(19) United States
(12) Patent Application Publication
(10) Pub. No.: US 2026/0252567 A1
(43) Pub. Date: Aug. 27, 2026

(54) EFFICIENTLY CAPTURING STATISTICS ON LONG RUNNING QUERIES

(71) Applicant: Google LLC, Mountain View, CA (US)

(72) Inventors: Suzhen Lin, Sunnyvale, CA (US); Edwin Howard Jacox, JR., San Francisco, CA (US)

(21) Appl. No.: 19/642,271

(22) Filed: Apr. 8, 2026

Related U.S. Application Data
(63) Continuation of application No. 18/515,162, filed on Nov. 20, 2023, now abandoned.

(51) Int. Cl. G06F 16/2455; G06F 11/34

(52) U.S. Cl. CPC G06F 16/24552; G06F 11/3419

(57) ABSTRACT

A computer-implemented method for efficiently capturing statistics on long running queries includes obtaining a query and obtaining a linked list including a plurality of records, each record in the plurality of records including respective query execution statistics. The method includes executing the query and, during execution of the query, obtaining new query execution statistics associated with the executing query. The method includes creating a new record in the linked list, the new record including the new query execution statistics. The method includes determining that a query execution duration of the query satisfies a query execution threshold. Further, the method includes identifying each record in the linked list that corresponds to the query. The method includes storing, for each respective identified record in the linked list that corresponds to the query, the respective query execution statistics of the respective identified record in a statistics database.

### CROSS REFERENCE TO RELATED APPLICATIONS

This U.S. patent application is a continuation of, and claims priority under 35 U.S.C. §120 from, U.S. Patent Application 18/515,162, filed on November 20, 2023. The disclosure of this prior application is considered part of the disclosure of this application and is hereby incorporated by reference in its entirety.

### TECHNICAL FIELD

This disclosure relates to efficiently capturing statistics on long running queries.

### BACKGROUND

As applications today generate significant amounts of data, systems, such as online analytical processing (OLAP) and online transactional processing (OLTP) systems, continue to evolve to support data analysis. Moreover, if a user is unable to perform analysis over his or her data in a manner that is efficient and/or cost-effective, the value of generating a vast amount of data may significantly diminish. To ensure that a user is able to make the best use of data, a user will want to ensure that the processing system is operating quickly and efficiently. For example, in a query processing system, a user can use query statistics related to the execution of a query to better understand the utilization of the database resources and the performance of the query processing system. In both OLAP and OLTP systems, a query may include insert, delete, update, and/or select functions, where the execution of any of these functions generates query statistics.

### SUMMARY

One aspect of the disclosure provides a computer-implemented method for efficiently capturing statistics on long running queries. The computer-implemented method is executed by data processing hardware that causes the data processing hardware to perform operations including obtaining a query corresponding to data at a data store and obtaining a linked list, the linked list including a plurality of records, each record in the plurality of records including respective query execution statistics. The operations include executing the query and, during execution of the query, obtaining new query execution statistics associated with the executing query. The operations further include creating a new record in the linked list, the new record including the new query execution statistics. The operations include determining that a query execution duration of the query satisfies a query execution threshold. The operations also include, in response to determining that the query execution duration of the query satisfies the query execution threshold, identifying each record in the linked list that corresponds to the query. The operations include storing, for each respective identified record in the linked list that corresponds to the query, the respective query execution statistics of the respective identified record in a statistics database (e.g., a data store or database table).

Implementations of the disclosure may include one or more of the following optional features. In some implementations, the operations include, in response to storing, for each respective identified record in the linked list that corresponds to the query, the respective query execution statistics of the respective identified record in the statistics database, deleting each identified record from the linked list. In some implementations, the operations further include obtaining a second query corresponding to the data at the data store and executing the second query. In these implementations, the operations include, during execution of the second query, obtaining second new query execution statistics and creating a second new record in the linked list, the second new record including the second new query execution statistics. In these implementations, the operations further include determining that a second query execution duration of the second query fails to satisfy the query execution threshold and, in response to determining that the second query execution duration of the second query fails to satisfy the query execution threshold, deleting the second new record from the linked list.

The new query execution statistics may include one or more of query statistics, wait event statistics, query processing statistics, and/or plan statistics. In some implementations, the collected statistics are either query statistics or other statistics such as instance statistics, session statistics, auxiliary process statistics, transaction statistics, etc. The query statistics may include plan statistics, wait event statistics, etc. In some implementations, the operations further include, in response to executing the query, creating a start record in a start list, the start record including a start time of the query. In these implementations, the operations may include, determining, based on the start record and a current time, the query execution duration for the query. Alternatively, in these implementations, the operations may further include, in response to completing execution of the query, creating an end record in an end list, the end record including an end execution time of the query. Here, the operations may further include, determining, based on the end record and the start record, the query execution duration for the query.

Obtaining the new query execution statistics may include retrieving the new query execution statistics from a shared memory of a query execution environment. In some implementations, the operations further include, transmitting, to a client device, a portion of the new query execution statistics that, when received by the client device, causes the client device to display the portion of the new query execution statistics via a user-interface of the client device.

Another aspect of the disclosure provides a system for efficiently capturing statistics on long running queries. The system includes data processing hardware and memory hardware in communication with the data processing hardware. The memory hardware stores instructions that when executed on the data processing hardware cause the data processing hardware to perform operations. The operations include obtaining a query corresponding to data at a data store and obtaining a linked list, the linked list including a plurality of records, each record in the plurality of records including respective query execution statistics. The operations include executing the query and, during execution of the query, obtaining new query execution statistics associated with the executing query. The operations further include creating a new record in the linked list, the new record including the new query execution statistics. The operations include determining that a query execution duration of the query satisfies a query execution threshold. The operations also include, in response to determining that the query execution duration of the query satisfies the query execution threshold, identifying each record in the linked list that corresponds to the query. The operations include storing, for each respective identified record in the linked list that corresponds to the query, the respective query execution statistics of the respective identified record in a statistics database (e.g., a data store or database table).

This aspect may include one or more of the following optional features. In some implementations, the operations include, in response to storing, for each respective identified record in the linked list that corresponds to the query, the respective query execution statistics of the respective identified record in the statistics database, deleting each identified record from the linked list. In some implementations, the operations further include obtaining a second query corresponding to the data at the data store and executing the second query. In these implementations, the operations include, during execution of the second query, obtaining second new query execution statistics and creating a second new record in the linked list, the second new record including the second new query execution statistics. In these implementations, the operations further include determining that a second query execution duration of the second query fails to satisfy the query execution threshold and, in response to determining that the second query execution duration of the second query fails to satisfy the query execution threshold, deleting the second new record from the linked list.

The new query execution statistics may include one or more of query processing statistics, wait event statistics, query statistics, and/or plan statistics. In some implementations, the collected statistics are either query statistics or other statistics such as instance statistics, session statistics, auxiliary process statistics, transaction statistics, etc. The query statistics may include plan statistics, wait event statistics, etc. In some implementations, the operations further include, in response to executing the query, creating a start record in a start list, the start record including a start time of the query. In these implementations, the operations may include, determining, based on the start record and a current time, the query execution duration for the query. Alternatively, in these implementations, the operations may further include, in response to completing execution of the query, creating an end record in an end list, the end record including an end execution time of the query. Here, the operations may further include, determining, based on the end record and the start record, the query execution duration for the query.

Obtaining the new query execution statistics may include retrieving the new query execution statistics from a shared memory of a query execution environment. In some implementations, the operations further include, transmitting, to a client device, a portion of the new query execution statistics that, when received by the client device, causes the client device to display the portion of the new query execution statistics via a user-interface of the client device.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for efficiently capturing statistics on long running queries.

FIG. 2 is a schematic view of an example collect and then discard or persist statistics collection framework in a process-based database system.

FIG. 3A is a schematic view of recording query statistics in a set of linked lists.

FIG. 3B is a schematic view of persisting query statistics in a set of linked lists to a query statistics database, and/or discarding query statistics in a set of linked lists.

FIG. 4 a flowchart of an example arrangement of operations for a method for efficiently capturing statistics on long running queries.

FIG. 5 is a schematic view of an example computing device that may be used to implement the systems and methods described herein.

Like reference symbols in the various drawings indicate like elements.

### DETAILED DESCRIPTION

For customers utilizing query systems, it can be helpful to understand their queries’ utilization of database resources and performance of workloads. These customers may also benefit from the ability to effectively troubleshoot any performance issues, including identifying reasons behind slow query execution, determining the phase in which a query is stuck, and understanding how system resources are utilized by queries. Statistics related to the execution of the query (e.g., run time, buffer usage, wait events) help provide insight into the operation of the query system. Customers not only desire these historical statistics after query completion, but also seek real-time insights during query execution. However, collecting extensive statistics (such as start time, query plan, resource usage, and wait events) is not practical. In particular, query systems can receive many queries, and the query statistics related to many of these queries may not be helpful and/or may not provide insight into the overall operation of the query system. Further, recording statistics for these short queries would require excessive memory usage and degradation of performance.

Implementations herein are directed to efficiently capturing statistics on long running queries in a query system, such as an online analytical processing (OLAP) system and/or an online transactional processing (OLTP) system. In particular, the current disclosure provides for prompt delivery of workload observability, including comprehensive and detailed query statistics for both real-time and historical workloads for queries that satisfy a threshold. The collected statistics may encompass various levels of information related to a query, such as session statistics, transaction statistics, query statistics, plan statistics, wait events statistics, buffer usage statistics, write-ahead logging (WAL) usage statistics, etc. In some implementations, the collected statistics can be session statistics, query processing statistics, transaction statistics, query statistics, plan statistics, wait events statistics, buffer usage statistics, write-ahead logging (WAL) usage statistics, etc. As used herein, query statistics are used as a generic placeholder for any statistics related to execution of a query. In some implementations, a statistics collection system is designed to optimally collect query statistics without impeding the performance of the query system by only collecting statistics for a subset of queries of the overall system. For example, collecting statistics for the subset of queries that satisfy a threshold, while discarding statistics for queries that do not satisfy the threshold, as this provides a reasonable tradeoff between collecting data while maintaining an efficient system. One approach of the current disclosure, called Collect and then Discard or Persist (CDP), includes collecting statistics for long-running queries generated by multiple processes in a database server (i.e., the threshold corresponds to a length of execution or running time of the query). Further, this approach may minimize memory usage by using data structures with non-contiguous memory, such as linked lists, and further enables the collection of both historical statistics and real-time statistics. The approach includes storing relevant statistics for a query in one or more linked lists and then making a determination whether to persist the statistics for the query. A background process may discard statistics related to queries that do not satisfy a threshold, while only persisting statistics related to queries that do satisfy the threshold to a database table (e.g., a permanent memory). The process may free the memory of removed or discarded nodes, thereby minimizing memory utilization.

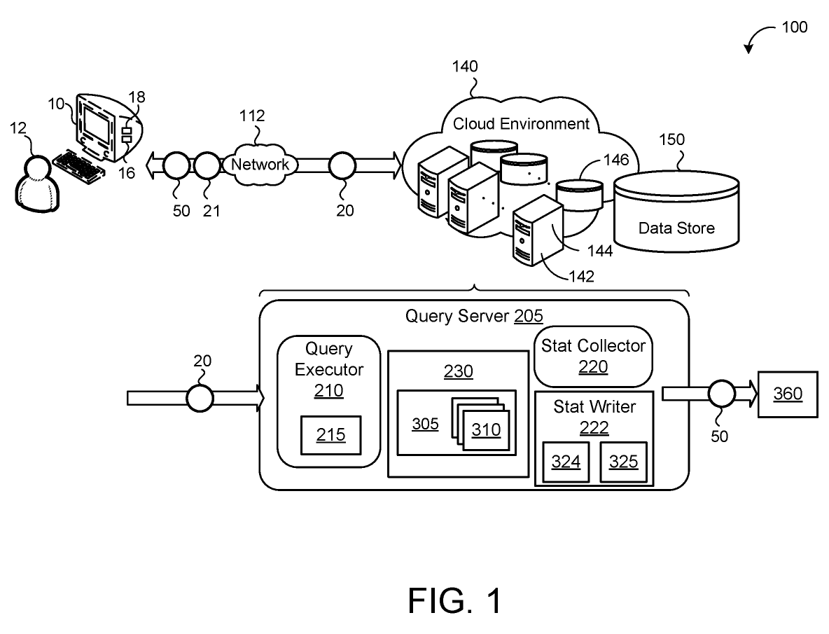

Referring to FIG. 1, in some implementations, a statistics collection system 100 includes a cloud environment 140 (e.g., a high-performance remote server or cluster of high-performance remote servers) in communication with one or more user devices 10 (also referred to herein as client devices 10) via a network 112. The client device 10 may be configured to submit one or more queries 20 (e.g., via an SQL interface or the like) to the cloud environment. The client device 10 may correspond to any computing device, such as a desktop workstation, a laptop workstation, or a mobile device (i.e., a smart phone). The user device 10 includes computing resources 18 (e.g., data processing hardware) and/or storage resources 16 (e.g., memory hardware).

The cloud environment 140 may be a single computer, multiple computers, or a distributed system having scalable / elastic resources 142 including computing resources 144 (e.g., data processing hardware) and/or storage resources 146 (e.g., memory hardware). The cloud environment 140 may be configured to execute a query server 205 for executing queries 20. A data store 150 (i.e., a remote storage device) may be overlain on the storage resources 146 to allow scalable use of the storage resources 146 by one or more of the clients (e.g., the user device 10) or the computing resources 144 (e.g., the query server 205). The data store 150 is configured to store data for queries 20. In other words, the queries 20 may be related to data stored at the data store 150. The data store 150 may also be configured to store data for the query statistics 50 of queries 20. In other words, the data store 150 may store both query data for queries 20 as well as query statistics 50 of executed queries 20.

The cloud environment 140 executes a query server 205 (including a query executor 210, shared memory 230, a statistics collector 220, and a statistics writer 222) for executing the query 20 against the data store 150. In some implementations, the query server 205 is a process based query system (i.e., a PostgreSQL based system). In these implementations, the query server 205 executes the query by one or more processes 215 of the query executor. Here, the query executor 210 may store data related to the query 20 into the shared memory 230 of the query server 205 before, during, and/or after execution of the query 20. In some implementations, the query executor 210 is configured to store query execution statistics 50 as one or more records 310 of a linked list 305.

The statistics collector 220 may obtain the query execution statistics 50 related to the query 20 from the shared memory 230 of the query server 205. The query execution statistics 50 may include any statistics 50 related to the execution of the query 20 such as wait event statistics, plan statistics, query processing statistics, buffer usage statistics, wal usage statistics, etc. In some implementations, the statistics collector 220 stores the collected statistics 50 in a record 310 of a linked list 305. That statistics collector 220 may periodically obtain statistics 50, and each time (i.e., at each time step the statistics collector 220 obtains the statistics 50) generate a new record 310 for the newly obtained statistics 50. Here, each record 310 of the linked list 305 may include a query identifier indicating a corresponding query 20. For example, the query server 205 may execute multiple queries 20 simultaneously. The statistics collector 220 may obtain statistics 50 related to each of the simultaneously executing queries 20, and generate a respective record 310 for the statistics 50 of the corresponding query 20, where the respective record 310 includes an identifier of the corresponding query 20 (i.e., that uniquely identifies the corresponding query 20). In some implementations, a hash table is used to store the query identification for each record 310 of the linked list.

The statistics writer 222 may transmit/write the statistics 50 to a query statistics database/table 360. In some implementations, the statistics writer 222 first determines whether a query execution duration 324 of the query 20 (i.e., an amount of time that elapsed during execution of the query 20) satisfies a threshold 325. When the query execution duration 324 of the query 20 satisfies the threshold 325, the statistics writer 222 persists the corresponding query statistics 50 of each record 310 in the linked list 305 that corresponds to the query 20. However, when the query execution duration 324 of the query 20 fails to satisfy the threshold 325, the statistics writer 222 discards the corresponding query statistics 50 of each record 310 in the linked list 305 that corresponds to the query 20. Thus, for each query 20 that takes longer to execute than the duration of time defined by the threshold 325, the statistics writer 222 persists the corresponding query statistics 50 of the query 20 to the statistics database/table 360. This allows the system 100 to collect statistics 50 for longer queries 20, which may allow the system 100 to capture statistics 50 for relevant queries 20 (e.g., longer queries 20 usually provide greater insight into the operation of the query server 205, as the longer queries may correspond to an error in execution). In other examples, the threshold 325 is related to any other characteristic of a query 20 that is deemed relevant to the functionality of the query server 205 (e.g., an amount of computational resources consumed). In these examples, the query server 205 may use other metrics derived from the query execution statistics 50 to determine whether the threshold 325 is satisfied.

When writing the statistics 50 to the statistics database/table 360, the statistics writer 222 may write each statistic 50 of the plurality of statistics 50 to a single data table 360 or multiple data tables 360. In some configurations, the statistics database/table 360is persistent and/or non-volatile such that data, by default, is not overwritten or erased by new incoming data. Further, the shared memory 230 and the statistics database/table 360 may be co-located in the same system (i.e., cloud environment 140).

In some examples, the data store 150 is a data warehouse (e.g., a plurality of databases) as a means of data storage for the user 12 (or multiple users). Generally speaking, the data store 150 stores data from one or more sources and may be designed to analyze, report, and/or integrate data from its sources. The data store 150 enables users (e.g., organizational users) to have a central storage depository and storage data access point. The data store 150 may simplify data retrieval for functions such as data analysis and/or data reporting (e.g., by the query server 205 for executing queries 20). Furthermore, the data store 150 may be configured to store a significant amount of data such that a user 12 (e.g., an organizational user) can store large amounts of historical data to understand data trends. Being that the data store 150 may be the main or sole data storage depository of data, the data store 150 may often be receiving large amounts of data (e.g., gigabytes per second, terabytes per second, or more) from user devices 10 associated with one or more users 12.

The query server 205 is configured to request information or data from the data store 150 when executing the query 20. In some examples, the query 20 is initiated by the user 12 (via client device 10) as a request for data within the data store 150 (e.g., an export data request). For instance, the user 12 interacts with the query server 205 (e.g., an interface, such as an SQL interface, associated with the query server 205) to retrieve data being stored in the data store 150 of the cloud environment 140. Here, the query 20 may be user-originated (i.e., directly requested by the user 12) or system-originated (i.e., configured by the query server 205 itself). In some examples, the query server 205 configures routine or repeating queries 20 (e.g., at some designated frequency) to allow the user 12 to perform analytics or to monitor data stored in the data store 150.

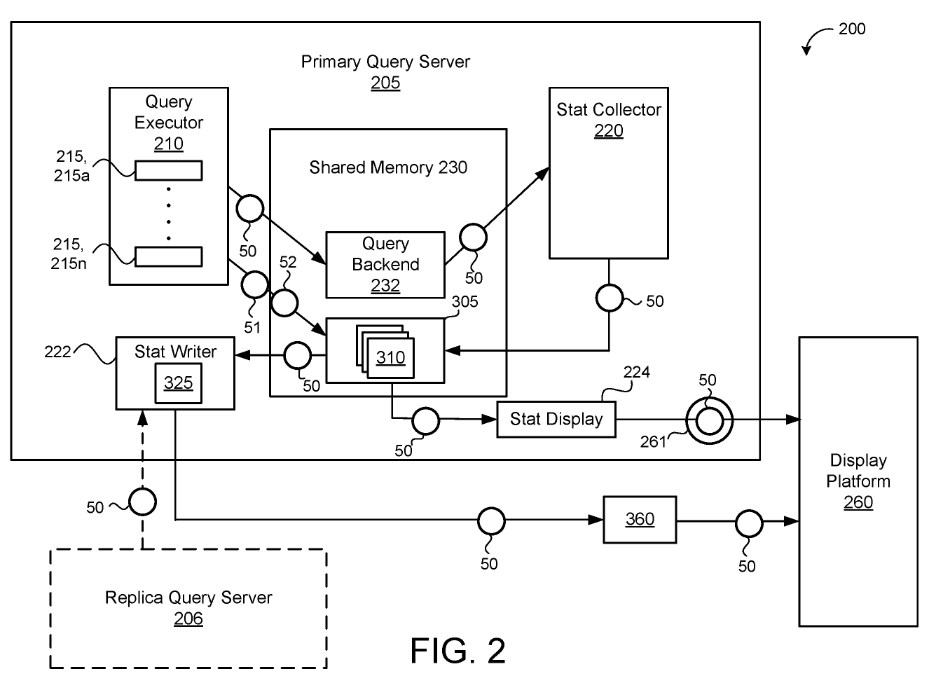

The format of the query 20 may vary, but generally includes reference to specific data stored in the data store 150. In response to the query 20, the query server 205 generates a query response 21 fulfilling or attempting to fulfill the request of the query 20 (e.g., a request for particular data). Generally speaking, the query response 21 includes data that the query server 205 obtains in response to the query 20. The query server 205 may return this query response 21 to an entity that originates the query 20 (e.g., the user 12) or another entity or system communicating with the system 100. Further, the query server 205 is also configured to collect statistics 50 related to the query 20. The user 12 may obtain the statistics 50 for one or more queries 20. In some implementations, the user 12 may interact with a user interface 261 (FIG. 2) that displays statistics 50 for some or all queries executed by the query server 205, providing insight into the overall performance of the query server 205.

The system 100 of FIG. 1 is presented for illustrative purposes only and is not intended to be limiting. For example, although only a single example of each component is illustrated, the system 100 includes any number of components 10, 140, 150, and 205. Further, although some components are described as being located in a cloud computing environment 140, in some implementations, some or all of the components may be hosted locally on the client device 10. Further, in various implementations, some or all of the components 150 and 205, are hosted locally on client device 10, remotely (such as in the cloud computing environment 140), or some combination thereof.

FIG. 2 schematically illustrates an example collect and then persist or discard (CDP) statistics collection framework 200. In some examples, the CDP statistics collection framework 200 is organized according to a process-based database query system, such as PostgreSQL. PostgreSQL itself follows a process-based architecture where different processes handle various tasks to ensure efficient and concurrent database operations (e.g., query execution). The postmaster process, also known as the “master server process,” is the parent process that manages the PostgreSQL system. The postmaster process starts and stops processes and manages client connections. For example, when a client connects to the PostgreSQL server, a client-connected backend process is spawned to handle that client’s request. Each client-connected backend process is responsible for managing transactions, executing queries, and interacting with the client. Other processes, called auxiliary processes, handle tasks in the background. Example auxiliary processes include background Writer, Checkpointer, Autovacuum Launcher and Worker Process, etc. In PostgreSQL, all of the backend processes have access to a shared memory pre-allocated during database startup.

The framework 200 includes the query server 205 that serves as a primary or master server that can perform both read and write operations. The query server 205 includes the query executor 210 that includes processes 215, a shared memory 230, and one or more linked lists 305 in the shared memory 230, a statistics collector 220, a statistics writer 222, and a statistics display 224. Though FIG. 2 only includes the shared memory 230, the query server 205 may execute queries 20 for any number of databases of the cloud environment 140. In some implementations, the shared memory 230 may be a shared memory that is accessible by a number of backend processes executing queries 20 for different databases. In these implementations, all of the backend processes store their corresponding query statistics 50 into the shared memory 230 (e.g., in a query backend 232). The statistics collector 220 is one type of backend process and it can access the shared memory 230 to retrieve query statistics 50. The query server 205 may initiate the processes 215, via the query executor 210, to execute the query 20, where each process 215 is responsible for a specific task in executing the query 20. Here, the processes 215 of the query server 205 may be configured to collect statistics 50 while executing the query 20. For example, the query executor 210 may store a query start time 51 and/or a query end time 52 in a record 310 of the linked list 305.

The query server 205 may act as a database management system allowing clients to create databases which can include a number of tables, each table including a list of columns. The primary query server 205 may include components such as a query processing component that can generate plans for a query execution engine to execute (i.e., query executor 210), a query execution component that can execute plans generated by the query processing engine, a transaction processing component, a storage management component, etc. In some implementations, in response to a query 20 (e.g., a read or write query 20 submitted by a user 12 via client device 10) to the query server 205, the query server 205 can execute the query 20 at any of the databases on the query server 205. That is, all the components of the query server 205 have access to retrieve write and/or retrieve data from a table of the database.

Key events in query 20 execution may be stored in the data structure (i.e., the query backend 232) within the shared memory 230. For live statistics 50, the statistics collector 220 may periodically pull the status from query backend 232 and generate a record 310 to store the obtained statistics 50 into the linked list 305. Further, a hash table may be defined to facilitate finding the event/activity record 310 in the linked list 305.

The statistics collector 220 may check the shared memory 230 to obtain statistics for all backends, these backends may be working on queries for different databases. The statistics collector 220 obtains the statistics 50 from the query backend 232 and then stores the statistics 50 to the linked list 305. A statistics writer 222 will periodically write (i.e., persist) the statistics 50 from each record 310 of the linked list 305 to the statistics database 360 (e.g., database table) for each query 20 that satisfies a threshold 325. In some implementations, the statistics collector 220 can access query backend statistics stored in the shared memory 230 to determine correlation among different events/activities.

In some implementations, the query backend 232 includes an array dedicated to store statistics 50 generated by the query executor 210. Each process 215 of the query executor 210 may correspond to a slot in the array such that the process 215 stores all of the corresponding statistics 50 in the corresponding slot of the array. In these implementations, the statistics collector 220 periodically sweeps the array of the query backend 232 to obtain all live backend process state (e.g., statistics 50), generates a record 310 for each process 215, and/or stores the record 310 in the linked list 305.

There are many factors to consider when collecting statistics 50 related to queries 20. In particular, performance impact and resource usage (e.g., CPU, memory, disk) must be considered, as degrading performance or overburdening the system would make statistics 50 collection unviable. To keep the overhead low, the query server 205 may implement various mechanisms during statistics 50 collection to reduce the amount of statistics 50 collected and accordingly minimize performance impact. For example, in transactional systems there may be numerous short queries 20 (i.e., queries 20 that have a short execution time relative to other queries 20), and collecting statistics 50 for all of these short queries 20 would produce an overwhelming amount of statistics 50. Thus, the statistics writer 222 only persists statistics 50 that exceed a duration of time defined by the threshold 325, which mitigates the risk of collecting statistics 50 for short queries 20.

A statistics display 224 may be configured to generate a user interface 261 including the statistics 50. The statistics display may transmit the user interface 261 to a display platform 260 (e.g., a client device) to display the user interface 261 to a user.

In some implementations, one or more replica query servers 206 are configured to perform read operations only. The replica query servers 206 may be configured like the query server 205 and include all of the elements of the query server 205. On the replica query server 206, the statistics writer 222 may port statistics 50 to the statistics writer 222 of the query server 205 allowing the statistics writer 222 of query server 205 to write the statistics 50 to the statistics database/table 360.

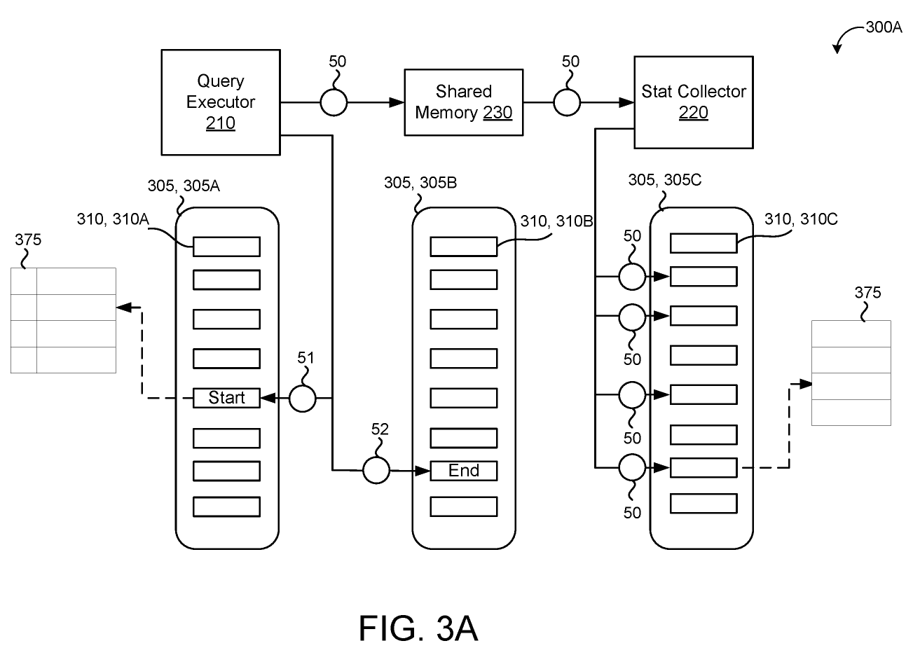

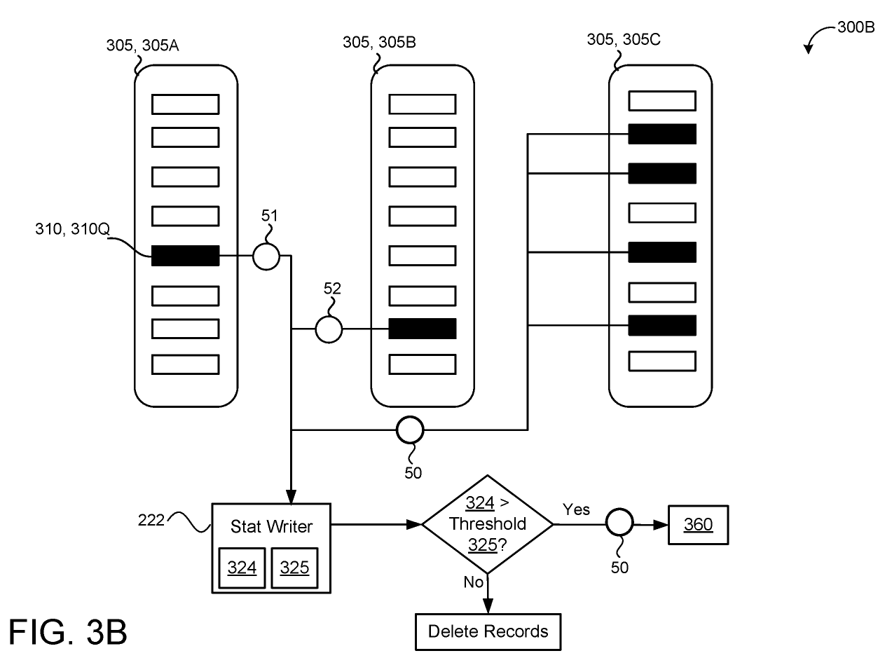

FIG. 3A is a schematic view 300A of recording query statistics 50 in a set of linked lists 305, 305A–C. In other words, the schematic view 300A illustrates the collect operations in the collect and then discard or persist (CPD) framework. In particular, during and/or after execution of the query, each of the query executor 210 and the statistics collector 220 may insert one or more records 310 in an event start linked list 305, 305A, an event end linked list 305, 305B, and/or a live stat linked list 305, 305C. The event start linked list 305A is created to store, by a backend process (e.g., query executor 210), an event query start time 51 which defines a point in time when a query 20 begins execution. In some implementations, a hash table 375 is used to store information related to each start record 310, 310A of the even start linked list 305. The hash table 375 may include a node pointer for each start record 310A of the even start linked list 305A indicating a corresponding query 20, facilitating easy retrieval and updating of the record 310 when the corresponding query 20 ends. Each entry of the hash table 375 may store a query identifier or ID and its node pointer in the event start linked list 305A.

The event end linked list 305B is created to store query 20 end information. The event end linked list 305B is needed in case the corresponding event start information of the corresponding query 20 (i.e., the event start record 310A) is not found in the event start linked list 305A. For example, the event start record 310A can be persisted to permanent storage prior to the end of the corresponding query 20. This will occur for long running queries 20, where the query 20 is determined to exceed the threshold 325 before the query 20 ends (i.e., the query execution duration 324 of the query 20 exceeds the threshold 325). In some implementations, when a query 20 ends (i.e., completes execution), the backend process that executes the query 20 (e.g., the query executor 210) checks the hash table 375 to see if the corresponding query ID exists in the event start linked list 305A. In these implementations, when the query ID does not exist in the event start linked list 305A, it creates an end record 310, 310B to store the query ID, a block read time together with other statistics 50 of the query 20, and a query end time 52, in the event end linked list 305B. In these implementations, when the query ID exists in the hash table 375, the query executor 210 updates the record 310A with the block read time and query end time 52 in the event start linked list 305A. When the query ID does not exist in the hash table 375 and/or when the elapsed time of the query 20 (based on the query start time 51 and the query end time 52) is greater than or equal to the threshold 325, the query executor creates a record 310B to save the query ID, the block read time together with other statistics 50 of the query 20, and the query end time 52 in the event end linked list 305B.

The live stat linked list 305C is created to store real-time statistics 50. Here, the statistics collector 220 may periodically obtain statistics 50 from the shared memory 230 and store the query statistics 50 as a live record 310, 310C at the live stat linked list 305C. Each live record 310C may include the query ID identifying the corresponding query, a snapshot time, a block read time, and other statistics 50 of the query 20. In some implementations, the hash table 375 is used to store the node pointer with each entry including the query ID (key) and a set of node pointers with the same query ID, identifying each live record 310C in the live stat linked list 305C that corresponds to the same query 20.

Each linked list 305A–C may include a start node and end node (e.g., an empty end node). When a new record 310 is added to the linked list 305, the new record 310 is added into the end node, and a new end node is generated. In some implementations, the end node of each linked list 305 is locked, where only the statistics writer 222 has access to add/delete/edit the end node. Locking only the end node allows the statistics writer 222 to remove nodes from the linked list 305 during the persist and/or discard process without holding the lock. The statistics writer 222 may hold the lock to obtain the end node pointer (i.e., the statistics writer 222 releases the lock immediately after obtaining the end node pointer) in order to persist and/or discard nodes starting from the start node to the node right before the end node. Other processes that acquire the end node pointer are backend processes that execute queries 20. In some implementations, the end node is always an empty end node. In these implementations, the backend process will populate the empty end node with statistics 50, create a new end node to attach to the old end node, and then release the end node lock. The competition on the end node lock among backend processes will be none since we will partition the linked list 305 to num-of-cpu lists. Further, when the new record 310 is added to the linked list 305, the hash table 375 may be updated accordingly. Further, when one or more records 310 are removed (i.e., deleted) from a linked list 305 (see FIG. 3B), the hash table 375 may be updated accordingly. In some implementations, one hash table 375 is configured to store pointers to each linked list 305. In other implementations, each linked list 305 corresponds to a unique hash table 375.

In some implementations, when the query executor 210 and/or the statistics collector 220 try to create a record 310 in a linked list 305, if the dedicated shared memory 230 reaches a predefined memory size threshold (e.g., 90%), the query executor 210 and/or the statistics collector 220 can send an asynchronous signal to the statistics writer 222 (FIG. 3B) to trigger the removal of records 310. In some implementations, query executor 210 and/or the statistics collector 220 stops generating new records 310 when insufficient shared memory 230 is available.

FIG. 3B is a schematic view 300B of persisting query statistics 50 in the set of linked lists 305A–C to a statistics database/table 360 (i.e., persistent storage) and/or discarding query statistics 50 in the set of linked lists 305A–C. In other words, the schematic view 300B illustrates the persist or discard operations of the CPD framework. In some implementations, a statistics writer 222 periodically scans the linked lists 305A–C to determine whether to persist or discard the statistics 50 stored in the records 310 of the linked lists 305. In some implementations, the statistics writer 222 may use a hash table 375 to identify each record 310, 310Q from each linked list 305A–C that corresponds to a particular query 20. In this example, each respective record 310Q that corresponds to a particular query 20 is denoted as a black rectangle. The statistics writer 222 may determine if the query 20 satisfies the threshold 325 (e.g., a query execution duration 324 of the query 20 satisfies the threshold 325). When the query 20 does satisfy the threshold 325, the statistics writer 222 persists the statistics 50 from each respective record 310Q that corresponds to the query 20 into the statistics database/table 360 . The statistics database/table 360 may be a permanent memory, a disk memory, a database, a data table, etc. When the query 20 does not satisfy the threshold 325, the statistics writer 222 may discard the statistics 50 from each respective record 310Q that corresponds to the query 20. In either the case of persisting or discarding, the statistics writer 222 removes/deletes each record 310Q from each corresponding linked list 305A–C.

In some implementations, the threshold 325 corresponds to a duration of time (i.e., the query execution duration 324). Here, the statistics writer 222 may determine the amount of time it takes to execute each query 20 and compare this duration to the threshold 325 to determine whether the query 20 satisfies the threshold 325 (e.g., is equal to, exceeds, or fails to exceed the threshold 325). The statistics writer 222 may determine the query execution duration 324 of the query 20 using the query start time 51 and the query end time 52. In some implementations, the statistics writer 222 determines the query execution duration 324 of the query 20 using the query start time 51 and a current time. For particularly long queries 20, the statistics writer 222 may begin to persist the query statistics 50 from the respective records 310Q prior to completion of the query 20. In these cases, the statistics writer 222 may store an indication that all respective records 310Q for the particular query 20 are to be persisted (i.e., any additional records 310Q that are created after the statistics writer 222 persisted existing records 310Q to the statistics database/table 360). In some implementations, the statistics writer 222 searches a start event linked list 305A for a respective start record 310A that corresponds to the query 20. In these implementations, if the respective start record 310A that corresponds to the query 20 does not exist in the start event linked list 305A (e.g., by searching hash table 375), the statistics writer 222 determines that the respective start record 310A has already been persisted to the statistics database/table 360 (i.e., that the query 20 has already satisfied the threshold based on the query start time 51 and a current time), and thus persist any additional respective records 310Q that correspond to the query 20.

When a query 20 has ended (i.e., an end record 310B corresponding to the query 20 is recorded in the event end linked list 305B) and the query 20 does not satisfy the threshold 325 (i.e., the query execution duration 324 is shorter than a duration of time of the threshold 325), all respective records 310Q corresponding to the query 20 are discarded/deleted. The statistics writer 222 may discard/delete records 310 in batches when consecutive records 310 need to be removed. Records 310Q with the same query ID (e.g., as determined by searching one or more hash tables 375) in the event start linked list 305A, the event end linked list 305B, and the live stat linked list 305C may be discarded simultaneously. In some implementations, when the query execution duration 324 does not satisfy the query execution threshold 325, the statistics collector 220 and/or the query executor 210 do not create a record 310 with the query end time in the event end linked list 305B (to avoid creating superfluous records 310). In these implementations, the event end linked list 305B will only include records 310 that are going to be persisted at a later time (i.e., the records 310 all correspond to queries 20 that satisfy the query execution threshold 325). The respective records 310Q can be located using the hash table 375 associated with the live stat linked list 305C. In some implementations, only the statistics writer 222 is allowed to remove records 310 from the linked lists 305.

The frequency with which the statistics writer 222 performs the persist or discard operations may depend on the implementation. For example, in a transactional database system, where numerous short queries 20 are common and the corresponding query statistics 50 have not been persisted, the shared memory 230 can quickly become overloaded, leading to out-of-memory (OOM) issues. In such cases, the statistics writer 222 may trigger the filtering process more frequently to remove unwanted records 310 in batch and quickly free up memory. In some implementations, the statistics writer 222 may persist statistics 50 less frequently to minimize the impact on IO performance.

FIGS. 3A and 3B are provided for illustrative purposes, and are not intended to be limiting. In particular, any number of linked lists 305 can be included as deemed necessary to collect query execution statistics 50. For example, statistics database/table 360 may include a number of linked data tables 360 organized according to a schema. In this example, the query server 205 may maintain a respective linked list 305 for each respective data table 360 in the statistics database/table 360. Alternatively, the query executor 210 and/or the statistics collector 220 may each write records 310 to a single linked list 305. In some implementations, each process 215 of the query executor may correspond to a respective linked list 305. Further, while the linked lists 305 are illustrated as being stored in a shared memory 230 of the query execution environment (i.e., the shared memory 230 of the query server 205), the linked lists 305 may be stored wholly or in a data repository outside of the query execution environment.

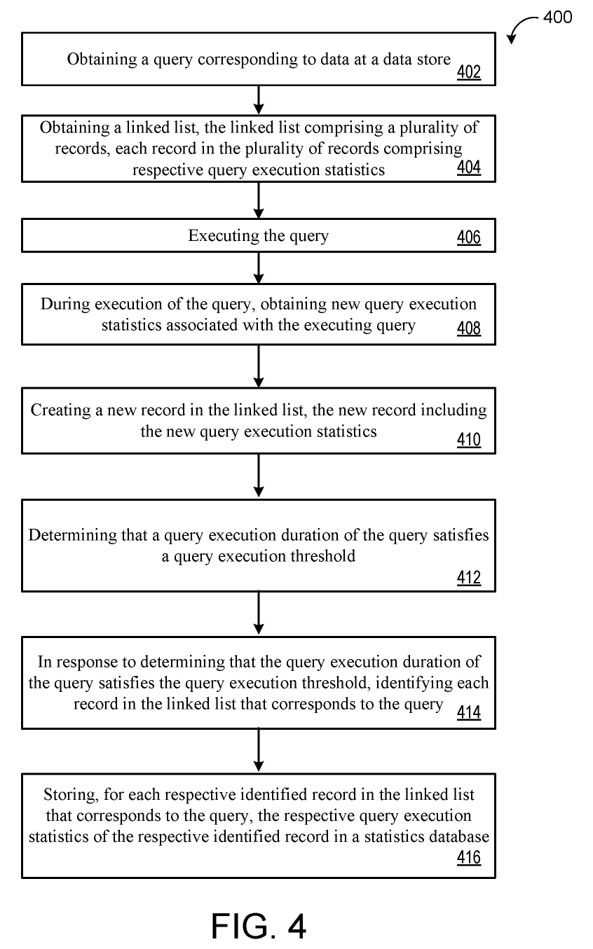

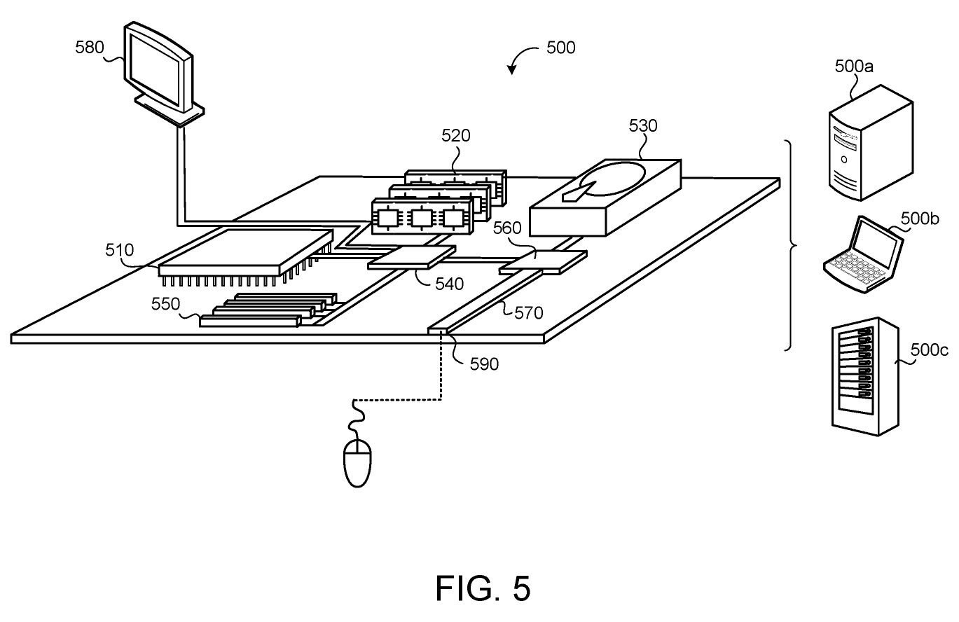

FIG. 4 is a flowchart of an exemplary arrangement of operations for a method 400 for efficiently capturing statistics on long running queries. The method 400 can be performed by various interconnected computing devices of a computing system, such as the components of the system 100 of FIG. 1 and/or the computing device 500 of FIG. 5. At operation 402, the method 400 includes obtaining a query 20 corresponding to data at a data store 150. At operation 404, the method 400 includes obtaining a linked list 305, the linked list 305 including a plurality of records 310, each record 310 in the plurality of records 310 including respective query execution statistics 50. At operation 406, the method 400 includes executing the query 20. At operation 408, the method 400 includes, during execution of the query 20, obtaining new query execution statistics 50 associated with the executing query 20. At operation 410, the method 400 includes creating a new record 310 in the linked list 305, the new record 310 including the new query execution statistics 50. At operation 412, the method 400 includes determining that a query execution duration 324 of the query 20 satisfies a query execution threshold 325. At operation 414, the method 400 includes, in response to determining that the query execution duration 324 of the query 20 satisfies the query execution threshold 325, identifying each record 310 in the linked list 305 that corresponds to the query 20. At operation 416, the method 400 includes storing, for each respective identified record 310 in the linked list 305 that corresponds to the query 20, the respective query execution statistics 50 of the respective identified record 310 in a statistics database/table 360.

FIG. 5 is a schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM) / programmable read-only memory (PROM) / erasable programmable read-only memory (EPROM) / electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A method comprising:
obtaining, by data processing hardware and from a shared memory, a set of linked lists comprising an event start linked list, a live statistics linked list, and an event end linked list;
detecting, by the data processing hardware, initiation of a query;
creating, by the data processing hardware and in the event start linked list, a record that includes a start time for an execution of the query;
during the execution of the query:
periodically obtaining, by the data processing hardware, query execution statistics; and
creating, by the data processing hardware and in the live statistics linked list, at least one record that includes the query execution statistics;
determining, by the data processing hardware and based on the start time and a current time for the execution of the query, a duration for the execution of the query;
in response to determining that the execution of the query has finished, creating, by the data processing hardware and in the event end linked list, a record that includes an end time for the execution of the query;
in response to determining that the duration satisfies a threshold duration, persisting, by the data processing hardware, data from at least the event start linked list and the live statistics linked list to a statistics database; and
in response to determining that that the duration does not satisfy the threshold duration and that the execution of the query has finished:
discarding, by the data processing hardware, data from the event start linked list, the live statistics linked list, and the event end linked list without persisting the data to the statistics database; and
deleting, by the data processing hardware, the data from the event start linked list, the live statistics linked list, and the event end linked list from the shared memory.

2. The method of claim 1, the method further comprising:
executing, by the data processing hardware, a backend process to create the record that includes the start time for the execution of the query, the at least one record that includes the query execution statistics, and the record that includes the end time for the execution of the query; and
executing, by the data processing hardware, a background statistics writer process to determine the duration for the execution of the query and to discard the data, wherein the data processing hardware executes the backend process and the background statistics writer process asynchronously.

3. The method of claim 2, wherein the data processing hardware executes the background statistics writer process to periodically scan the data to determine whether to discard the data or to persist the data.

4. The method of claim 2, wherein the method further comprises:
in response to determining that a predefined memory size threshold of the shared memory is satisfied, sending, by the data processing hardware, an asynchronous signal to the background statistics writer process to trigger deletion of the data from the shared memory.

5. The method of claim 1, wherein creating the record in the event end linked list further comprises:
checking, by the data processing hardware, a hash table to determine if a query identifier corresponding to the query exists in the event start linked list; and
in response to determining that the query identifier does not exist in the event start linked list, creating, by the data processing hardware, the record in the event end linked list.

6. The method of claim 1, further comprising:
in response to determining that that the duration does satisfy the threshold duration and that the execution of the query has finished, persisting, by the data processing hardware, the data from the event end linked list to the statistics database.

7. The method of claim 6, wherein the method further comprises:
retrieving, by the data processing hardware and from the statistics database, at least a portion of the data; and
transmitting, by the data processing hardware and to a client device, the portion of the data, wherein the portion of the data, when received by the client device, causes the client device to display the portion of the data via a user interface of the client device.

8. The method of claim 1, wherein the query execution statistics include one or more of query processing statistics and block read times.

9. A computing system comprising:
one or more processors; and
a memory storing instructions, that, when executed by the one or more processors, cause the one or more processors to:
obtain, from a shared memory, a set of linked lists comprising an event start linked list, a live statistics linked list, and an event end linked list;
detect initiation of a query;
create, in the event start linked list, a record that includes a start time for an execution of the query;
during the execution of the query:
periodically obtain query execution statistics; and
create, in the live statistics linked list, at least one record that includes the query execution statistics;
determine, based on the start time and a current time for the execution of the query, a duration for the execution of the query;
in response to determining that the execution of the query has finished, create, in the event end linked list, a record that includes an end time for the execution of the query;
in response to determining that the duration satisfies a threshold duration, persist data from at least the event start linked list and the live statistics linked list to a statistics database; and
in response to determining that that the duration does not satisfy the threshold duration and that the execution of the query has finished:
discard data from the event start linked list, the live statistics linked list, and the event end linked list without persisting the data to the statistics database; and
delete the data from the event start linked list, the live statistics linked list, and the event end linked list from the shared memory.

10. The computing system of claim 9, wherein the instructions further cause the one or more processors to:
execute a backend process to create the record that includes the start time for the execution of the query, the at least one record that includes the query execution statistics, and the record that includes the end time for the execution of the query;
execute a background statistics writer process to determine the duration for the execution of the query and to discard the data; and
execute the backend process and the background statistics writer process asynchronously.

11. The computing system of claim 10, wherein the instructions further cause the one or more processors to execute the background statistics writer process to periodically scan the data to determine whether to discard the data or to persist the data.

12. The computing system of claim 10, wherein the instructions further cause the one or more processors to:
in response to determining that a predefined memory size threshold of the shared memory is satisfied, send an asynchronous signal to the background statistics writer process to trigger deletion of the data from the shared memory.

13. The computing system of claim 9, wherein to create the record in the event end linked list, the instructions further cause the one or more processors to:
check a hash table to determine if a query identifier corresponding to the query exists in the event start linked list; and
in response to determining that the query identifier does not exist in the event start linked list, create the record in the event end linked list.

14. The computing system of claim 9, wherein the instructions further cause the one or more processors to:
in response to determining that that the duration does satisfy the threshold duration and that the execution of the query has finished, persist the data from the event end linked list to the statistics database.

15. The computing system of claim 14, wherein the instructions further cause the one or more processors to:
retrieve, from the statistics database, at least a portion of the data; and
transmit, to a client device, the portion of the data, wherein the portion of the data causes the client device to display the portion of the data via a user interface of the client device.

16. The computing system of claim 9, wherein the query execution statistics include one or more of query processing statistics and block read times.

17. A non-transitory computer-readable storage medium comprising instructions that, when executed by one or more processors, cause the one or more processors to:
obtain, from a shared memory, a set of linked lists comprising an event start linked list, a live statistics linked list, and an event end linked list;
detect initiation of a query;
create, in the event start linked list, a record that includes a start time for an execution of the query;
during the execution of the query:
periodically obtain query execution statistics; and
create, in the live statistics linked list, at least one record that includes the query execution statistics;
determine, based on the start time and a current time for the execution of the query, a duration for the execution of the query;
in response to determining that the execution of the query has finished, create, in the event end linked list, a record that includes an end time for the execution of the query;
in response to determining that the duration satisfies a threshold duration, persist data from at least the event start linked list and the live statistics linked list to a statistics database; and
in response to determining that that the duration does not satisfy the threshold duration and that the execution of the query has finished:
discard data from the event start linked list, the live statistics linked list, and the event end linked list without persisting the data to the statistics database; and
delete the data from the event start linked list, the live statistics linked list, and the event end linked list from the shared memory.

18. The non-transitory computer-readable storage medium of claim 17, wherein the instructions further cause the one or more processors to:
execute a backend process to create the record that includes the start time for the execution of the query, the at least one record that includes the query execution statistics, and the record that includes the end time for the execution of the query;
execute a background statistics writer process to determine the duration for the execution of the query and to discard the data; and
execute the backend process and the background statistics writer process asynchronously.

19. The non-transitory computer-readable storage medium of claim 18, wherein the instructions further cause the one or more processors to execute the background statistics writer process to periodically scan the data to determine whether to discard the data or to persist the data.

20. The non-transitory computer-readable storage medium of claim 18, wherein the instructions further cause the one or more processors to:
in response to determining that a predefined memory size threshold of the shared memory is satisfied, send an asynchronous signal to the background statistics writer process to trigger deletion of the data from the shared memory.
